(19) United States
(12) Patent Application Publication
(10) Pub. No.: US 2013/0300694 A1
(43) Pub. Date: Nov. 14, 2013

(54) STYLUS BARREL FOR RECEIVING A STYLUS

(71) Applicant: StepOver GmbH, Stuttgart (DE)

(72) Inventor: Andreas Guenther, Ostfildern (DE)

(73) Assignee: StepOver GmbH, Stuttgart (DE)

(21) Appl. No.: 13/890,653

(22) Filed: May 9, 2013

(30) Foreign Application Priority Data
May 9, 2012 (EP) 12167358.6

(51) Int. Cl. G06F 3/0354

(52) U.S. Cl. CPC G06F 3/03545
USPC 345/173; 345/179

(57) ABSTRACT

A stylus barrel includes a barrel tip configured to input handwritten user data into or on an electronic input field. A chamber is defined within the stylus barrel and is configured to accommodate and retain a stylus that is also configured to input handwritten user data into or on an electronic input field. The stylus and/or the stylus barrel may include a fastener that detachably fastens the stylus within the chamber of the stylus barrel.

### CROSS-REFERENCE

The present application claims priority to European patent application no. 12 167 358.6 filed on May 9, 2012, the contents of which are incorporated herein by reference as if fully set forth herein.

### TECHNICAL FIELD

The present disclosure relates to a stylus barrel having an accommodating chamber for accommodating a stylus. The stylus barrel has a stylus barrel tip for inputting handwritten user data, for example a signature, in an input field.

The present disclosure also relates to a writing implement having a stylus barrel and a stylus, for inputting handwritten user data in an input field.

The present disclosure additionally relates to a stylus having fastening means for securing the stylus in an accommodating chamber of a stylus barrel.

Furthermore, the present disclosure relates to a signature device having a housing, an input field, a retaining device and a writing implement for inputting handwritten user data in an input field.

### BACKGROUND

Devices for capturing handwritten user data generally comprise a housing which can be fastened on a wall or can be positioned on an underlying surface. This housing has, on its front side, an input field, in which a user can input handwritten data, for example signatures, by means of a stylus. Such devices are also known as signature pads.

Signature pads have different areas of use, for which the signature pad and the writing implement for inputting handwritten user data have to meet different requirements. Therefore, for mobile use, the signature pad is often transported in a pocket, which requires the writing implement to be stowed in a reliable manner for transportation. In contrast to this, for example for use at a counter, the signature pad and the writing implement, for all practical purposes, are never transported, although they are used very frequently.

Whereas thin writing implements are well suited to mobile use, since they can be easily stowed in a reliable manner for transportation in or on the housing, these thin stylus' are comparatively difficult to handle. The difficult handling of the thin stylus is noticeable in particular when it is in frequent use.

If the writing implement is used frequently, it has been proven to be recommendable to use writing implements with ergonomic shaping. These are often thicker than writing implements which frequently have to be stowed in a reliable manner for transportation. Stowage of these thicker, ergonomic writing implements in a reliable manner for transportation is possible only to a limited extent.

A further problem of writing implements for signature pads is that they are often difficult to change over when they are worn or damaged. The reason for the difficult changeover is a cord or tie which connects the stylus to the signature pad in order to safeguard it against accidental loss and against theft. The problem relating to difficult exchange on account of wear or damage arises, in particular, in the case of frequent use, as is often the case, for example, with the use of the aforementioned ergonomic writing implements.

Writing implements for signature pads are known, for example, from DE 10 2009 044 139 A1.

A technical problem on which the present disclosure is based may be said to be that of eliminating, or at least finding better solutions for, one or more of the aforementioned problems.

### SUMMARY OF THE DISCLOSURE

According to a first aspect of the present disclosure, a stylus barrel may have a barrel tip. The barrel tip may be designed to input handwritten user data in an input field. The stylus barrel may have an accommodating chamber. The accommodating chamber may be designed to accommodate, and retain, a stylus.

The first aspect of the disclosure is based on the concept of providing an easy-to-exchange and more user-friendly writing implement for inputting handwritten user data in an input device. It is thus possible for frequent use, for example at a counter, to use a now ergonomic writing implement which, in the event of wear as a result of frequent use, can be easily changed over. In areas of use in which the writing implement frequently has to be stowed in a reliable manner for transportation, it is possible to use, in the usual manner, just the stylus as the writing implement. The stylus can easily be accommodated in or on the housing of the signature pad. A manufacturer can thus make available a signature pad with a writing implement which is not already better suited in advance, on account of a thick or thin writing implement, for certain areas of use. Providing a comparatively thin stylus and a stylus barrel makes it possible for the user to select the writing implement which is suitable for the area of use and preferred by the user.

According to the disclosure, the handwritten user data can be input in an input field by the tip of the stylus barrel. This tip of the stylus barrel is modelled on the tip of the stylus. If the tip of the stylus barrel is worn as a result of frequent use, or damaged as a result of incorrect use, then the stylus barrel of the writing implement can easily be changed over. The stylus barrel thus functions as a kind of exchangeable “outer core” (“outer lead”).

According to an exemplary embodiment of the present disclosure, the stylus may be likewise designed for inputting handwritten user data in the input field.

According to a further exemplary embodiment of the present disclosure, the stylus barrel may have a fastening means for securing the stylus in a releasable manner in the stylus barrel. It is thus possible for the stylus to be pushed into the stylus barrel and fastened, and therefore the stylus cannot fall out or be pulled out. For example, it is possible for the fastening means to be arranged at an end of the stylus barrel which is located opposite the barrel tip.

In a further exemplary embodiment of the present disclosure, the fastening means of the stylus barrel may be designed as a latching device. This latching device may allow releasable connection to at least one corresponding latching hook of the stylus. As a further example, it is also possible for the fastening means of the stylus barrel to be designed as an internal thread. This internal thread in the accommodating chamber of the stylus barrel can then undergo releasable connection to an external thread of the stylus.

According to a further aspect of the present disclosure, a writing implement for inputting handwritten user data in an input field of a signature device is disclosed. The writing implement may comprise a stylus barrel and a stylus. The stylus barrel may have an accommodating chamber for a stylus and a barrel tip for inputting handwritten user data in an input field. The stylus can be pushed into the accommodating chamber of the stylus barrel.

According to a further aspect of the present disclosure, a stylus which may be designed for inputting handwritten user data in an input field is disclosed. The stylus may have a fastening means for securing the stylus in a releasable manner in a stylus barrel. For example, this fastening means of the stylus may be designed as at least one latching hook, in order to undergo releasable connection to a corresponding latching device of a stylus barrel. As an alternative, the fastening means of the stylus may be designed, for example, as an external thread. This external thread can undergo releasable connection to a corresponding internal thread in an accommodating chamber of a stylus barrel.

According to a further aspect of the present disclosure, a signature device which may comprise a writing implement, a housing and an input field is disclosed The writing implement may comprise a stylus barrel and a stylus, which can be pushed into an accommodating chamber of the stylus barrel. The stylus barrel may have a barrel tip for inputting handwritten user data in the input field. The stylus, which can be pushed into the accommodating chamber of the stylus barrel, may be likewise designed for inputting handwritten user data in an input field. The input field may be provided on a front side of the housing and may be designed to capture handwritten user data input by means of a stylus and/or the stylus barrel of the writing implement.

In an exemplary embodiment, the device may also comprise at least one retaining device. This retaining device may be designed to retain both the tip of the stylus and the tip of the stylus barrel. This may be made possible by the stylus tip and the barrel tip being of essentially the same outer shape. It is thus possible for this retaining device to be used both for the stylus and for a writing implement having a stylus barrel.

In an exemplary embodiment, the input field may be, in particular, an electronic input field. The electronic input field may be designed to capture handwritten user data input by a writing implement. Therefore, as long as a writing implement may be guided over the electronic input field, the electronic unit captures Cartesian x and y coordinates of the writing-implement tip on the electronic input field with associated writing pressure and time-related information.

In an alternative exemplary embodiment to that just described, the stylus barrel and/or the stylus may have an electronic unit. The electronic unit may make it possible to capture handwritten user data input in an input field, which may be designed, for example, as a glass surface, a plastics surface, a screen or the like. In order for the electronic unit to be supplied with power, a (rechargeable) battery may be provided in the stylus barrel and/or in the stylus. In addition, an electronic unit provided in the stylus barrel may make it possible to provide stylus barrels with different functionalities. It is thus conceivable, for example, to have stylus barrel with and without pressure stages and different levels of accuracy. Furthermore, it may be, for example, possible for the stylus or the stylus barrel to be provided with input means, for example input buttons and switches, via which the user can make adjustments. These adjustments may relate, for example, to the functionalities which have just been described, and which would therefore also be available with a switchover function in a stylus barrel. As an alternative, or in addition, the electronic unit of the stylus barrel may comprise a coding. This coding can be read out by a suitable device. The coding may be, for example, an RFID chip. It is conceivable for the coding to contain information in respect of the writing characteristics, for example colour and stroke thickness, and/or person-specific data, for example digital certificates. In this context, it is also possible for the stylus to be designed merely as a means for retaining the stylus barrel. Such a retaining stylus need not itself be designed for inputting handwritten user data in the input field.

### BRIEF DESCRIPTION OF THE DRAWINGS

FIG. 1 shows a plan view of an exemplary embodiment of a writing implement according to the disclosure for inputting handwritten user data in an input field,

FIG. 2 shows a section through that exemplary embodiment of a writing implement according to the disclosure for inputting handwritten user data in an input field which was shown in FIG. 1,

FIG. 3 shows a section through the rear end of an exemplary embodiment of a writing implement according to the disclosure,

FIG. 4 shows an exemplary embodiment of a fastening means of a stylus barrel according to the present disclosure,

FIG. 5 shows a section through an exemplary embodiment of the present disclosure in which a retaining device is retaining a writing implement, and

FIG. 6 shows a plan view of an exemplary embodiment according to the present disclosure comprising a signature pad with a retaining device and writing implement.

### DETAILED DESCRIPTION OF EXEMPLARY EMBODIMENTS

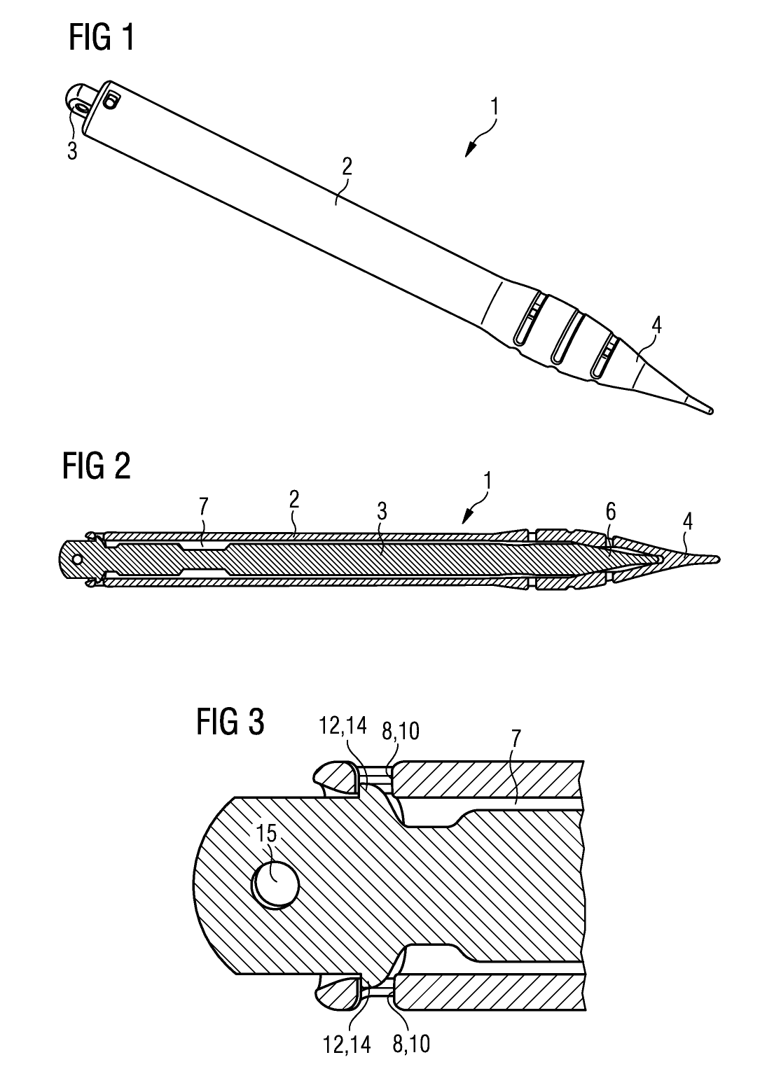

FIG. 1 shows an exemplary embodiment of the present writing implement 1 according to the disclosure. The writing implement 1 comprises a stylus barrel (pen casing) 2 and a stylus (pen) 3. The stylus 3 is located in the stylus barrel 2. For inputting handwritten user data in an input field, the stylus barrel 2 has a barrel tip (casing tip) 4.

As is shown in FIG. 2, the stylus 3 is accommodated in the accommodating chamber (receiving chamber) 7 of the stylus barrel. The stylus 3 also has, as does the stylus barrel 2, a stylus tip (pen tip) 6, for inputting handwritten user data in an input field. It is thus also possible according to the disclosure for the stylus 3 to be used as a writing implement without the stylus barrel 2. This takes account of the different requirements in respect of frequency of use and transportability of the writing implement.

The tip 6 of the stylus 3 is of a similar outer shape to the tip 4 of the stylus barrel 2. On the one hand, this means that there is no change in the writing characteristics of the writing implement 1 in relation to the stylus 3 alone being used; on the other hand, the similarity in shape is expedient in respect of a joint retaining device 16, which will be explained at a later stage in the text and is intended for retaining the writing implement 1 and/or the stylus 3.

As an alternative to the stylus 3 with stylus tip 6, which is designed for inputting handwritten user data in an input field, the stylus 3 may also be a retaining stylus, which is designed, in particular, for retaining the stylus barrel 2, but not for inputting handwritten user data in an input field.

The fastening means 8 of the stylus barrel 2 and the fastening means 12 of the stylus 3 can be seen from FIG. 3, which shows an enlargement of the rear end of the section through the writing implement 1 in FIG. 2. In the exemplary embodiment of the present disclosure which is shown, the fastening means 8 is designed as a latching device 10 and the fastening means 12 is designed as a latching hook 14. It is therefore possible for the stylus 3, once it has been pushed into the accommodating chamber 7 of the stylus barrel 2, to be latched therein by means of the latching hook 14 in the latching device 10. The fastening means 8 and 12 thus allow the stylus 3 to be secured in a releasable manner in the accommodating chamber 7 of the stylus barrel 2.

The stylus barrel 2 is produced, for example, from a plastics material. The plastics material allows for the elastic deformation of the latching hooks 14 when the stylus 3 is latched into the latching device 10 of the stylus barrel 2. A latching-in action can be initiated, for example, by rotation of the stylus 2, which is already located in the accommodating chamber 7. As an alternative, or in addition, it is possible for a latching-in action to be initiated, for example, by additional pressure being applied to a rear end of the stylus 2, which is already located in the accommodating chamber 7 of the stylus barrel 2.

As an alternative to the latching hooks 14 and the latching device 10 illustrated, other embodiments of the fastening means 8 and 12 are likewise conceivable. For securing in a releasable manner, the stylus 3 may have, for example, an external thread (not illustrated), which allows the user to screw the stylus 3 into an internal thread (not illustrated) of the accommodating chamber 7 of the stylus barrel 2 during or after the operation of pushing the stylus into the accommodating chamber 7.

A cord or a tie can be guided through the opening 15 of the stylus 3, in order to connect the stylus 3, and thus the writing implement 1, to a signature device 18.

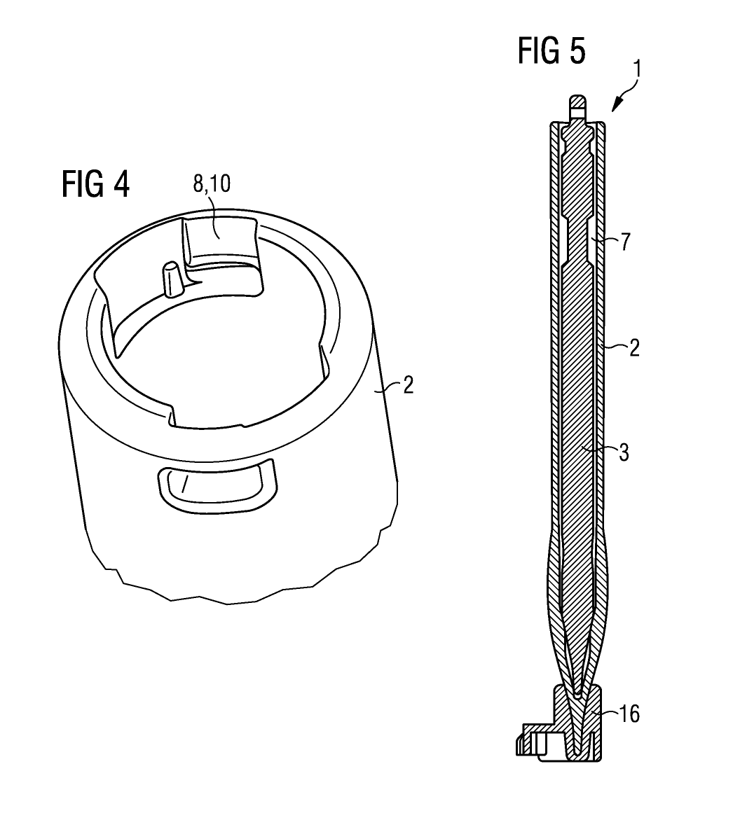

FIG. 4 shows an exemplary embodiment of the fastening means 8 of the stylus barrel 2. The fastening means 8 is designed as a latching device 10. A stylus 3 with latching hooks 14 can be pushed into the stylus barrel 2. Thereafter, the stylus 3 or the stylus barrel 2 is rotated in order for the latching hooks 14 to be latched into the latching device 10. In order for the stylus 3 to be released from the latching device 10 of the stylus barrel 2, the latching hooks 14 of the stylus 3 first of all have to be rotated out of the latching device 10. The stylus 3 can then be pulled out of the accommodating chamber 7 of the stylus barrel 2.

FIG. 5 illustrates how the writing implement 1 according to the disclosure, comprising the stylus barrel 2 and stylus 3, is retained in a retaining device 16. The retaining device 16 retains the writing implement 1 at the tip 4 of the stylus barrel 2 by means of a form fit.

The similarity in shape of the tip 4 of the stylus barrel 2 to the tip 6 of the stylus 3 means that this retaining device 16 can retain both the stylus 3, at its tip 6, and the stylus barrel 2, at its tip 4, by means of a form fit in the retaining device 16.

The retaining device 16 has a retaining chamber, which is designed as an internal cone. The conical retaining chamber makes it possible for the stylus tip 6 and/or the barrel tip 4 to be retained by means of a form fit.

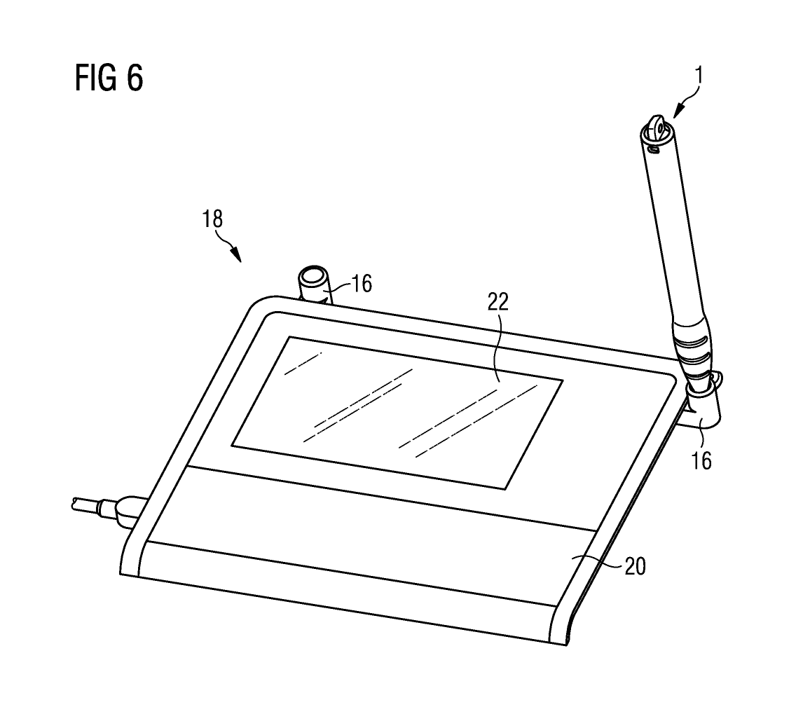

FIG. 6 shows a signature device 18. The signature device 18 comprises a housing 20, which has an input field 22, for handwritten user data input, on its front side. The signature device 18 also has, by way of example, two retaining devices 16. The writing implement 1 is retained at a barrel tip 4 in a retaining device 16. Of course, it is possible to vary the number and/or arrangement of the retaining device(s) 16 in embodiments other than the exemplary embodiment illustrated in FIG. 6.

The writing implement 1 has the advantage that it can be suitable both for frequent use and for frequent transportation. Wear to the writing implement 1 as a result of frequent use can be countered by easy changing of the stylus barrel 2. In addition, in the case of frequent use, the user benefits from the ergonomic shape of the writing implement 1, which is easier to handle than the thin stylus 3. Furthermore, in the case of frequent transportation, it is possible to use just the stylus 3, which can be stowed, without any large amount of space being required, in a reliable manner for transportation in or on the housing 20.

Furthermore, the writing implement 1 can be used for a large number of penabled devices. These devices comprise, in particular, those on which a writing implement is fastened and/or mobile devices. These devices include, inter alia, signature pads, penabled tablet computers, penabled smartphones and penabled handheld consoles.

Representative, non-limiting examples of the present disclosure were described in detail above with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide an improved stylus barrel, an improved stylus and an improved electronic signature device, as well as methods for making and using the same.

Moreover, the combinations of features and steps disclosed in the above detailed description may not be necessary to practice the disclosure in the broadest sense, and are instead taught merely to particularly describe representative examples of the disclosure. Furthermore, various features of the above-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1.-13. (canceled)

14. A stylus barrel comprising:
a barrel tip configured to input handwritten user data into or on an electronic input field, and
a chamber defined within the stylus barrel and configured to accommodate and retain a stylus.

15. The stylus barrel according to claim 14, wherein the stylus is also configured to input handwritten user data into or on the electronic input field.

16. The stylus barrel according to claim 14, wherein:
the stylus has a tip with an outer shape and
the barrel tip has an outer shape that is at least essentially the same as the outer shape of the stylus tip.

17. The stylus barrel according to claim 14, further comprising a fastener configured to detachably secure the stylus within the chamber of the stylus barrel.

18. The stylus barrel according to claim 17, wherein the fastener is a fastening means for detachably securing the stylus within the chamber of the stylus barrel.

19. The stylus barrel according to claim 18, wherein the fastening means is arranged at an end of the stylus barrel which is located at an opposite axial end from the barrel tip.

20. The stylus barrel according to claim 19, wherein the fastening means includes a latching device configured to detachably latch with at least one corresponding latching hook of the stylus.

21. The stylus barrel according to claim 18, wherein the fastening means includes an internal thread in the stylus barrel, the fastening means being configured to detachably engage an external thread of the stylus.

22. The stylus barrel according to claim 19, wherein:
the stylus has a tip with an outer shape configured to input handwritten user data into or on the electronic input field and
the barrel tip has an outer shape that is configured to input handwritten user data into or on the electronic input field and that is at least essentially the same as the outer shape of the stylus tip.

23. A writing implement configured to input handwritten user data in or on an electronic input field of an electronic signature device, comprising:
the stylus barrel according to claim 14, and
a stylus configured to input handwritten user data in the electronic input field.

24. The writing implement according to claim 23, wherein:
the stylus has a tip with an outer shape,
the barrel tip has an outer shape that is at least essentially the same as the outer shape of the stylus tip, and
the stylus barrel further comprises a fastening means configured to detachably secure the stylus within the chamber of the stylus barrel.

25. The writing implement according to claim 24, wherein the fastening means is arranged at an end of the stylus barrel which is located at an opposite axial end from the barrel tip.

26. The writing implement according to claim 24, wherein the fastening means includes at least one latching hook configured to detachably latch with at least one corresponding latching hook of the stylus.

27. The writing implement according to claim 24, wherein:
the stylus has an external thread, and
the fastening means includes an internal thread in the stylus barrel, the fastening means being configured to detachably engage the external thread of the stylus.

28. A stylus comprising:
a tip configured to input handwritten user data in or on an electronic input field; and
a fastening means configured to detachably secure the stylus within a chamber of a stylus barrel.

29. The stylus according to claim 28, wherein the fastening means includes at least one latching hook configured to detachably latch with a corresponding latching device of the stylus barrel.

30. The stylus according to claim 28, wherein the fastening means of the stylus includes an external thread configured to detachably engage a corresponding internal thread of the stylus barrel.

31. An electronic signature device comprising:
the writing implement of claim 23,
a housing having a front side; and
an electronic input field provided on the front side of the housing, the electronic input field being configured to capture handwritten user data input caused by the stylus and/or the stylus barrel movably contacting the electronic input field.

32. The electronic signature device according to claim 31, further comprising:
at least one retaining device coupled to the housing and configured to retain both the barrel tip and a tip of the stylus tip.
